(19) United States
(12) Patent Application Publication
(10) Pub. No.: US 2015/0094918 A1
(43) Pub. Date: Apr. 2, 2015

(54) SYSTEM, METHOD, AND VEHICLE FOR SAFE DRIVING

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(21) Appl. No.: 14/496,372

(22) Filed: Sep. 25, 2014

(30) Foreign Application Priority Data
Sep. 30, 2013 (TW) 102135435

(51) Int. Cl. F16H 59/44

(52) U.S. Cl. CPC F16H 59/44
USPC 701/51

(57) ABSTRACT

The present invention provides a system, a method, and a vehicle for safe driving. The vehicle includes a speed sensor, an automatic gearbox, a processor, and a communication unit. The vehicle communicates with a server via the communication unit. The processor executes a determining module and a speed control module. The determining module determines whether the vehicle receives a signal including a safe driving speed. When the signal is received, and a current speed of the vehicle is greater than the safe driving speed or less than the safe driving speed a preset value, the speed control module directs the automatic gearbox to set the speed of the vehicle to a constant speed equal to or less than the safe driving speed.

### CROSS-REFERENCE TO RELATED APPLICATIONS

This application claims priority to Taiwanese Patent Application No. 102135435 filed on Sep. 30, 2013, the contents of which are incorporated by reference herein.

### FIELD

The subject matter herein generally relates to safe driving, and particularly to systems, methods and vehicles for safe driving.

### BACKGROUND

Bad roads may increase the risk of road accidents for a driver, thus, there is a strong demand for safe driving systems and methods.

### BRIEF DESCRIPTION OF THE DRAWINGS

Implementations of the present technology will now be described, by way of example only, with reference to the attached figures.

FIG. 1 is a block diagram illustrating an example embodiment of a vehicle for safe driving.

FIG. 2 is a diagrammatic illustration of an example embodiment of an input interface provided by a data processing device.

FIG. 3 is a diagrammatic illustration of an example embodiment of a road in which locations of traffic accidents have occurred are marked.

FIG. 4 is a block diagram illustrating an example embodiment of a system for safe driving.

FIG. 5 is a flow chart illustrating an example embodiment of a method for safe driving.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein, However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein.

Several definitions that apply throughout disclosure will now be presented. The term “module” refers to logic embodied in computing or firmware, or to a collection of software instruction, written in a programming language, such as Java, C, or assembly. One or more software instruction in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “coupled” is defined as connected, whether directly or indirectly through intervening components, and is not necessarily limited to physical connections. The connection can be such that the objects are permanently connected or releasably connected. The term “comprising” means “including, but not necessarily limited to”, it specifically indicates open-ended inclusion or membership in a so-described combination, group, series and the like.

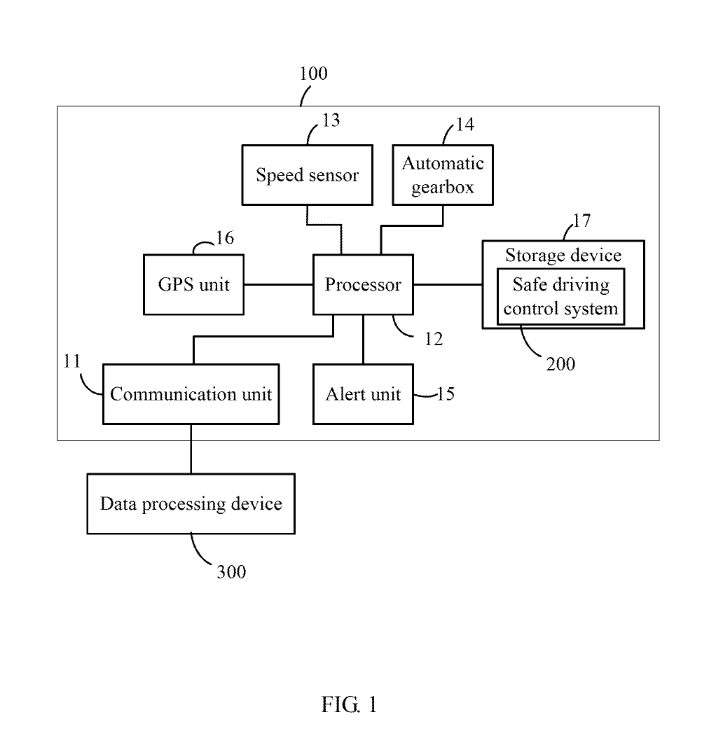

FIG. 1 illustrates a block diagram of a vehicle 100. The vehicle 100 can be a truck, a car, a bus, and the like. In at least one embodiment, the vehicle 100 can include a communication unit 11, a processor 12, a speed sensor 13, an automatic gearbox 14, an alert unit 15, a global position system (GPS) unit 16, and a storage device 17. The speed sensor 13, the automatic gearbox 14, the alert unit 15, and the GPS unit 16 are coupled to the processor 12. In one embodiment, the processor 12 can be a central processing unit, a digital signal processor, or a single chip, for example. In one embodiment, the storage device 17 is coupled to the processor 12. The storage device 17 can be an internal storage system, such as a flash memory, a random access memory (RAM) for temporary storage of information, and/or a read-only memory (ROM) for permanent storage of information. The storage device 17 can also be a storage system, such as a hard disk, a storage card, or a data storage medium. The storage device 17 can include volatile and/or non-volatile storage devices. In at least one embodiment, the storage device 17 can include two or more storage devices such that one storage device is a memory and the other storage device is a hard drive. Additionally, one or more of the storage devices 17 can be located either entirely or partially external relative to the vehicle.

The vehicle 100 communicates with a data processing device 300 via the communication unit 11. The communication unit 11 can be a wireless communication chip including the 3rd Generation Telecommunication (3G) card, a telecom card, or can be a wired communication chip, such as a wired network card. In the embodiment, the data processing device 300 can be an external electronic device including a processor (not shown) and a storage device (not shown), such as a computer, a printed circuit board, and the like. In other embodiments, the data processing device 300 also can be one or more processors integrated in the vehicle 100.

In this embodiment, the data processing device 300 stores a warning area list. The warning area list records locations of a number of warning areas in different roads and a number of safe driving speeds corresponding to the warning areas. In one embodiment, the data processing device 300 can be a peripheral of the vehicle 100. In other embodiments, the data processing device 300 can be a part of the vehicle 100.

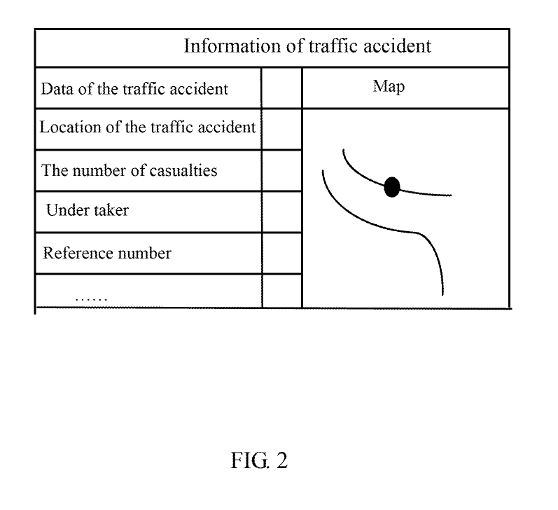

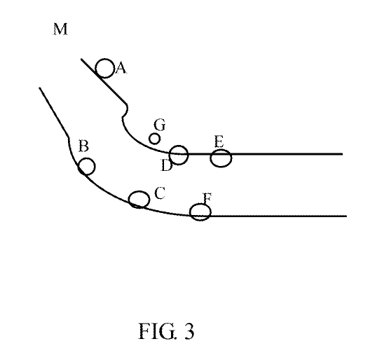

In at least one embodiment, a method for the data processing device 300 to determine the location of one warning area is provided as follows: first, the data processing device 300 obtains information of traffic accidents happened previously in a road, the information of each traffic accident can include a location the traffic accident happened, a date the traffic accident happened, and the like. In one embodiment, the data processing device 300 can provide an input interface as shown in FIG. 2, for users (such as traffic polices) to input the information of the happened traffic accidents. In other embodiments, the data processing device 300 can obtain the information of traffic accidents from a database of a transport agency. Second, the data processing device 300 further determines a danger area in where more than preset number of traffic accidents have happened in a preset past time period (such as one year) and in where a distance between each two traffic accidents is less than a preset value (such as 200 meters). At last, the data processing device 300 determines the warning area according to the locations of the traffic accidents in the danger area. For example, if the data processing device 300 determines that there are six traffic accidents A˜F have happened in a past year in a road section M of a road, as shown in FIG. 3, and the distance between the locations of the six traffic accidents A˜F is less than 200 meters, thus the data processing device 300 determines the section M as the danger area, and then determines the warning area according to the locations of the traffic accidents in the danger area.

In detail, the data processing device 300 determines the warning area according to the locations of the traffic accidents in the danger area as follows: first, the data processing device 300 first determines a coordinate of a center of the traffic accidents happened in the danger area. For example, the data processing device 300 can determine the center of the six traffic accidents A˜F as follows: the data processing device 300 determines a number of different geometric shapes enclosing the location of the six traffic accidents happened, such as a triangle, a round, a rectangle . . . ; the data processing device 300 then determines area values of the number of geometric shapes as A1, A2, A3 . . . A6, and determines the coordinates of the center of the number of geometric shapes as (x1, y1), (x2, y2), (x3, y3) . . . (x6, y6); assuming the coordinate of the center of the locations of the traffic accidents is (x, y), then the data processing device 300 determines the coordinate of the center of the six traffic accidents A˜F according to a formula: x=(A1x1+A2x2+A3x3+ . . . A6x6)/(A1+A2+A3+ . . . A6), y=(A1y1+A2y2+A3y3+ . . . +A6y6)/(A1+A2+A3+ . . . A6), thus, the data processing device 300 can determine the coordinate (x, y) of the center of the locations of the traffic accidents. Second, the data processing device 300 further determines distances between the center of the traffic accidents and the location of each traffic accident, and determines a longest distance S from the determined distances. Finally, the data processing device 300 determines a circular area whose center is the location of the center of the traffic accidents and whose radius is a preset multiple of the longest distance S as the warning area. In other embodiments, if the preset multiple of the longest distance S is less than a preset distance (such as 1 Km), the data processing device 300 determines the circular warning area using the preset distance as the radius. It can be understand that the warning area list can be updated in real time due to new traffic accidents are happened in the danger area.

The data processing device 300 further sets the safe driving speed corresponding to each determined warning area according to a traffic accident frequency in the warning area and a limited speed of the warning area. Here, the limited speed is set by the government, and is used to limit a maximum speed that vehicles may reaches when travelling on the road. In detail, if the data processing device 300 determines that there is a high frequency of traffic accidents happening in the warning area, the data processing device 300 determines a warning level of the warning area as a high warning level, and determines the safe driving speed corresponding to the warning area as a value equals to the limit speed minus a relative larger value, such as 20 kilometers/hour(km/h); if the data processing device 300 determines that there is a low frequency of the traffic accidents happening in the warning area, the data processing device 300 determines the warning level of the warning area as a low warning level, and determines the safe driving speed corresponding to the warning area as a value equals to the limit speed minus a relative smaller value, such as 10 km/h. For example, if the data processing device 300 determines that there are more than six traffic accidents happened in the past year in the warning area, the data processing device 300 determines that there is a high frequency of the traffic accidents happening in the warning area, and determines the warning level of the warning area as the high warning level, the data processing device 300 further determines the safe driving speed equals to the speed limit minus 20 km/h. If the data processing device 300 determines that there are less than four traffic accidents happened in the past year in the warning area, the data processing device 300 determines that there is a low frequency of the traffic accidents happening in the warning area, and determines the warning level of the warning area as the low warning level, the data processing device 300 further determines the safe driving speed equals to the speed limit minus 10 km/h.

The GPS unit 16 of the vehicle 100 is coupled to the processor 12 and is configured to sense a current location of the vehicle 100 in real time.

The processor 12 controls the communication unit 11 to send the current location of the vehicle 100 sensed by the GPS unit 16 to the data processing device 300.

If the data processing device 300 receives the current location of the vehicle 100, the data processing device 300 determines whether the current location of the vehicle 100 is within one of the warning areas recorded in the warning area list. If the data processing device 300 determines that the current location of the vehicle 100 is within one of the warning areas, the data processing device 300 determines a safe driving speed corresponding to the warning area that the vehicle 100 is located in, and sends a signal including the determined safe driving speed to the vehicle 100.

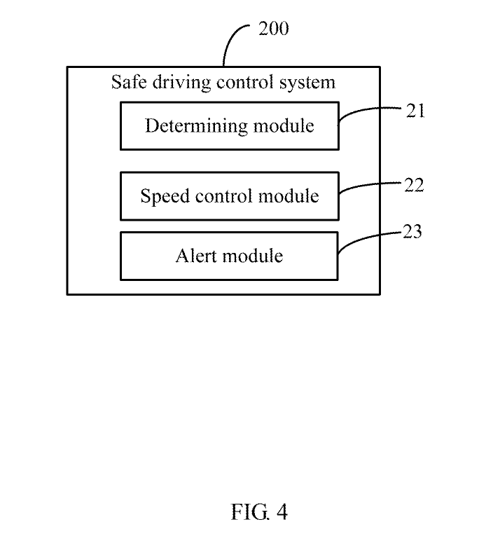

FIG. 4 illustrates an embodiment of a safe driving control system 200. In this embodiment, the safe driving control system 200 can include a number of modules, which are collection of software instructions stored in the storage device 17 and executed by the processor 12. In at least one embodiment, the safe driving control system 200 can include a determining module 21, a speed control module 22, and an alert module 23.

The determining module 21 determines whether the signal including the safe driving speed is received from the data processing device 300 via the wireless communication unit 11.

If the determining module 21 determines that the signal including the safe driving speed is received from the data processing device 300, the speed control module 22 determines whether a current speed of the vehicle 100 sensed by the speed sensor 13 is greater than or close to the safe driving speed included in the signal received from the data processing device 300. In this embodiment, “close to” means that the current speed of the vehicle 100 is less than the safe driving speed for a predefined range, such as 0˜2 km/h. If the speed control module 22 determines that the current speed of the vehicle 100 is greater than the received safe driving speed or close to the received safe driving speed, the speed control module 22 controls the automatic gearbox 14 to adjust the current speed of the vehicle 100 to a constant speed equals to or less than the safe driving speed received from the data processing device 300. After the speed adjusted by the speed control module 22, the vehicle 100 cannot be speeded up by the driver until the vehicle 100 get away from the warning area. In this embodiment, the automatic gearbox 14 is a well known electronic automatic gearbox.

In this embodiment, if the speed control module 22 determines that the current speed of the vehicle 100 is greater than the safe driving speed or close to the safe driving speed, the alert module 23 controls the alert unit 15 to output an alert signal to prompt the driver that the vehicle 100 is in a warning area. In this embodiment, the alert unit 15 can be a loudspeaker or a light source.

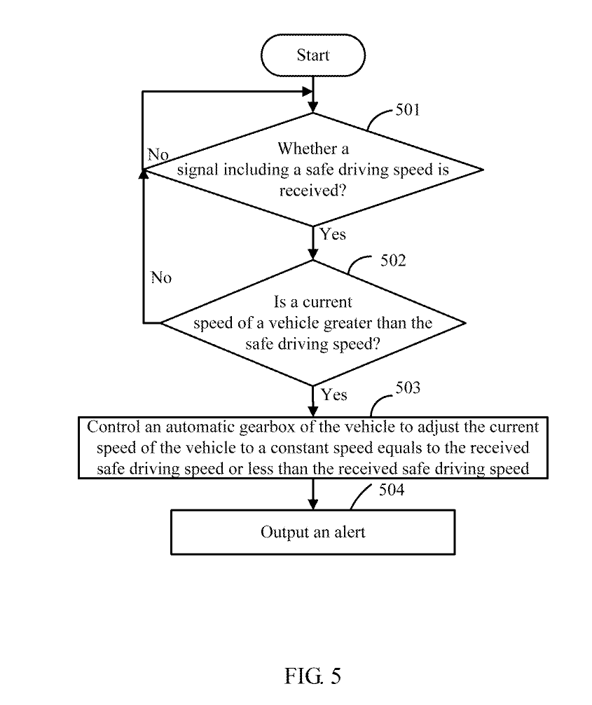

FIG. 5 illustrates an embodiment of a safe driving method applied in a vehicle. The method is provided by way of example, as there are a variety of ways to carry out the method. The method described below can be carried out using the configurations illustrated in FIG. 1, for example, and various elements of these figures are referenced in explaining the example method. Each block shown in FIG. 5 represents one or more processes, methods, or subroutines carried out in the example method. Additionally, the illustrated order of blocks is by example only and the order of the blocks can be changed. The example method can begin an block 501.

At block 501, a determining module of the vehicle determines whether a signal including a safe driving speed is received, if yes, the procedure goes to block 502, otherwise, the procedure go back to block 501.

At block 502, a speed control module of the vehicle determines whether a current speed of the vehicle sensed by a speed sensor is greater than the safe driving speed, if yes, the procedure goes to block 503, otherwise, the procedure goes back to block 501.

At block 503, the speed control module controls an automatic gearbox of the vehicle to adjust the current speed of the vehicle to a constant speed equals to the received safe driving speed or less than the received safe driving speed.

At block 504, an alert module controls an alert unit of the vehicle to output an alert.

In this embodiment, before the determining module determines whether the signal including the safe driving speed is received, the method can further include:

a GPS unit senses a current location of the vehicle;

a data processing device determines whether the current location of the vehicle is within one of locations of warning areas recorded in a warning area list, the warning area list records locations of a plurality of warning areas and a plurality of safe driving speed corresponding to the warning areas;

the data processing device further generates the signal including the safe driving speed if the data processing device determining that the current location of the vehicle is within one of the location of the warning areas.

The embodiments shown and described above are only examples. Many further details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A safe driving control system configured to control a speed of a vehicle, comprising:
a determining module, stored in a storage device, comprising at least one instruction configured to cause a processor of the vehicle to determine whether a signal comprising a safe driving speed is received from a data processing device; and
a speed control module, stored in the storage device, comprising at least one instruction configured to cause the processor of the vehicle to determining whether a current speed of the vehicle is greater than or close to the safe driving speed comprised in the signal received from the data processing device if the determining module determines that the signal comprising a safe driving speed is received from the data processing device, and controlling an automatic gearbox to adjust the current speed of the vehicle to a speed equals to or less than the safe driving speed comprised in the signal received from the data processing device if the current speed of the vehicle is greater than or close to the safe driving speed comprised in the signal received from the data processing device.

2. The safe driving control system of claim 1, further comprising an alert module stored in the storage device and comprising at least one instruction configured to cause an alert unit of the vehicle to output an alert signal if the speed control module determining that the current speed the vehicle is greater than the safe driving speed or close to the safe driving speed.

3. A vehicle comprising:
a communication unit to communicate with a data processing device;
a storage device;
a processor coupled to the storage device;
a speed sensor coupled to the processor and configured to sense a current speed of the vehicle;
an automatic gearbox coupled to the processor;
a determining module stored in the storage device and comprising at least one instruction configured to cause the processor to determine whether a signal comprising a safe driving speed is received from the data processing device;
a speed control module stored in the storage device and comprising at least one instruction configured to cause the processor to determine whether the current speed of the vehicle sensed by the speed sensor is greater than or close to the safe driving speed comprised in the signal received from the data processing device if the determining module determines that the signal comprising a safe driving speed is received from the data processing device, and controlling the automatic gearbox to adjust the current speed of the vehicle to a speed equals to or less than the safe driving speed comprised in the signal received from the data processing device.

4. The vehicle of claim 3, further comprising an alert unit, an alert module stored in the storage device and comprising instructions configured to cause the processor to control the alert unit to output an alert signal if the speed control module determining that the current speed the vehicle is greater than the safe driving speed or close to the safe driving speed.

5. The vehicle of claim 4, wherein the alert unit is a loudspeaker or a light source.

6. A safe driving control method applied in a vehicle comprising:
determining whether a signal comprising a safe driving speed is received, by a processor of the vehicle;
determining whether a current speed of the vehicle is greater than the safe driving speed by the processor of the vehicle if the processor determining that the signal comprising the safe driving speed is received; and
controlling an automatic gearbox of the vehicle to adjust a current speed of the vehicle to the received safe driving speed or less than the received safe driving speed if determining that the current speed of the vehicle is greater than the safe driving speed.

7. The safe driving control method of claim 6, wherein before determining whether a signal comprising a safe driving speed is received, the method further comprising:
sensing a current location of the vehicle by a global position system unit of the vehicle;
determining whether the current location of the vehicle is within one of locations of warning areas recorded in a warning area list stored in an storage device by a data processing device, wherein the warning area list records locations of a plurality of warning areas and a plurality of safe driving speed corresponding to the warning areas; and
generating the signal comprising the safe driving speed by the data processing device if the data processing device determining that the current location of the vehicle is within one of the location of the warning areas.

8. The safe driving control method of claim 7, wherein the method for determining a warning area comprises:
obtaining information of the traffic accidents by the data processing device, wherein the information of information of each traffic accident inputted by the users comprises a location the traffic accident happened, and a date the traffic accident happened;
determining a danger area wherein more than preset number of traffic accidents have happened in a preset past time period and in where a distance between each two traffic accidents is less than a preset value; and
determining the warning area by the data processing device according to the locations of the traffic accidents in the danger area.

9. The safe driving control method of claim 8, wherein the method for determining the warning area according to the locations of the traffic accidents in the danger area comprises:
determining a coordinate of a center of traffic accidents happened in the danger area before by the data processing device;
determining distances between the center of the traffic accidents and the location of each traffic accident by the data processing device;
determining a longest distance from the determined distances by the data processing device; and
determining a circular area, whose center is the location of the center of the traffic accidents and whose radius is a preset multiple of the longest distance, as the warning area.

10. The safe driving control method of claim 9, wherein the method for determining the center of the traffic accidents comprises:
determining a number of different geometric shapes enclosing the location of the traffic accidents happened by the data processing device;
determining area values of the number of geometric shapes as A1, A2, A3 . . . , and determines the coordinates of the center of the number of geometric shapes as (x1, y1), (x2, y2), (x3, y3) . . . by the data processing device; and
assuming the coordinate of the center of the locations of the traffic accidents is (x, y), determining the coordinate of the center of the traffic accidents according to a formula: x=(A1x1+A2x2+A3x3+ . . . )/(A1+A2+A3+ . . . ), y=(A1y1+A2y2+A3y3+ . . . )/(A1+A2+A3+ . . . ), by the data processing device.

11. The safe driving control method of claim 10, wherein if determining that the preset multiple of the longest distance is less than a preset distance, determining the preset distance as the radius of the warning area by the data processing device.

12. The safe driving control method of claim 7, wherein the safe driving speed corresponding to each determined warning area is set according to a traffic accident frequency happening in the warning area and a limit speed of the warning area; if the data processing device determines that there is a high frequency of traffic accidents happening in the warning area, the data processing device determines a warning level of the warning area as a high warning level, and determines the safe driving speed corresponding to the warning area as a value equals to the limit speed minus a relative larger value; if the data processing device determines that there is a low frequency of the traffic accidents happening in the warning area, the data processing device determines the warning level of the warning area as a low warning level, and determines the safe driving speed corresponding to the warning area as a value equals to the limit speed minus a relative smaller value.

13. The safe driving control method of claim 7, wherein the warning area list is updated in real time due to new traffic accidents happened in the danger area.
